(19) United States
(12) Patent Application Publication
(10) Pub. No.: US 2016/0270379 A1
(43) Pub. Date: Sep. 22, 2016

(54) Fishing Hook with Moveably Attached Jighead

(71) Applicant: Manny Perez, Punta Gorda, FL (US)

(72) Inventor: Manny Perez, Punta Gorda, FL (US)

(21) Appl. No.: 14/662,542

(22) Filed: Mar. 19, 2015

(51) Int. Cl. A01K 85/00; B21F 45/12; A01K 83/00

(52) U.S. Cl. CPC A01K 85/00; A01K 83/00; B21F 45/12

(57) ABSTRACT

The present invention comprises a fishing hook, that further comprises an eye, a weighted jighead movably attached to said eye, a shank extending from said eye comprising a bend, a barb located near an end of said shank which terminates in a point at the end of said shank, and a gap which defines the bend as a distance between the shank and the point. According to one aspect of the present invention, a bait can be attached to said weighted jighead and attached to said shank via the barb and the point, and a movement of the bait when attached to said weighted jighead and attached to said shank via the barb and the point mimics a natural caridoid escape reaction of an arthropod.

### FIELD OF THE INVENTION

The present invention relates to a fishing hook apparatus.

### BACKGROUND OF THE INVENTION

There are a large number of different types of fish hooks. Generally, the common categories of hooks include bait hooks, fly hooks and lure hooks. Within these broad categories there are wide varieties of hook types designed for different applications. Hook types differ in shape, materials, points and barbs, and eye type as well as in their intended application.

When individual hook types are designed, the specific characteristics of each of the hook components can be optimized relative to the hook's intended purpose. Many factors contribute to hook design, including corrosion resistance, weight, strength, hooking efficiency, and whether the hook is being used for specific types of bait, on different types of lures or for different styles of flies. The present invention relates to a specific hook design not now in use in the industry.

### SUMMARY OF THE INVENTION

It is, therefore, an object of the present invention to provide a fishing hook. It is another object of the present invention to provide a method of using said fishing hook. A method to service such fishing hook is also contemplated.

One exemplary embodiment of the present invention comprises a fishing hook having an eye, a weighted jighead, a shank, a barb and a gap.

In one exemplary aspect of the present embodiment, the weighted jighead can be movably attached to the eye.

In another exemplary aspect of the present embodiment, the shank can extend from the eye and can further comprise a bend.

In yet another exemplary aspect of the present embodiment, the barb can be located near an end of the shank. Furthermore, in another exemplary aspect of the barb, the barb can terminate in a point at the end of said shank.

In yet still another exemplary aspect of the present embodiment, the gap can define the bend as a distance between the shank and the point.

In yet a further exemplary aspect of the present embodiment, a bait can be attached to the weighted jighead and also attached to the shank via the barb and the point.

In an additional exemplary aspect of the present embodiment, a movement of the bait when attached to the weighted jighead and attached to the shank via the barb and the point mimics a natural caridoid escape reaction of an arthropod.

The fishing hook of claim 1, wherein the weighted jighead further comprises at least one posterior division and at least one posterior appendage of a crustacean, which forms a fan-like shape.

The following are additional and/or exemplary aspects of the present embodiment, one or more of which can be combined with the basic invention as embodied above:
the weighted jighead can further comprise an attachment apparatus which further comprises a spiral shape;
the weighted jighead can further comprise a density in a range between one eighth (0.125) ounces to one (1) ounce;
the weighted jighead can be cast in at least one material comprising lead, steel, brass, bismuth, a metallic amalgam, a composite resin, or other dense and low corrosive material;
the weighted jighead can be movably attached to the eye via an open-ended, curved attachment apparatus;
the gap distance can further define a size of the fishing hook in a range between thirty-two (32) and twenty aught (20/0);
the bait can be an artificial bait further comprised of a soft, plastic-based material; and
the bait can be a live crustacean.

An another exemplary embodiment of the present invention can be a fishing hook, comprising an eye, a shank, a weight, a barb and a gap.

In one exemplary aspect of this present embodiment, the shank can extend from the eye and can comprise a bend.

In another exemplary aspect of this present invention, the weight can be affixed to said shank.

In yet another exemplary aspect of this present embodiment, the barb can be located near an end of the shank and can further terminate in a point at the end of the shank.

In yet still another exemplary aspect of this present embodiment, the gap can define the bend as a distance between the shank and the point.

In a further exemplary aspect of this present embodiment, a bait can be affixed to the shank via an attachment element of the weight affixed to the shank.

The following are additional and/or exemplary aspects of the present embodiment, one or more of which can be combined with the basic invention as embodied above:
the weight can further comprise a fan-like shape formed to mimic at least one posterior division and at least one posterior appendage of a crustacean;
a movement of the bait when attached to the fishing hook can mimic a natural caridoid escape reaction;
the weighted jighead can further comprise a density in a range between one eighth (0.125) ounces to one (1) ounce; and
the gap distance can further be defined as a size of the fishing hook in a range between thirty-two (32) and twenty aught (20/0);

One exemplary method of manufacturing a movably attachable jighead as described in the exemplary embodiments can comprise the following steps:
forming an attachment apparatus;
placing at least a portion of said formed spiral-shaped attachment apparatus in a mold having a fan-like shape formed to mimic at least one posterior division and at least one posterior appendage of a crustacean;
pouring at least one liquefied material comprising lead, steel, brass, bismuth, a metallic amalgam, a composite resin, or other dense and low corrosive material into said mold; and
solidifying said at least one liquefied material to form the movably attachable weighted jighead.

The following are additional and/or exemplary aspects of the present method embodiment, one or more of which can be combined with the basic invention as embodied above:
the attachment apparatus having a spiral-shape;
the weighted jighead being movably attached to a fishing hook and a bait is attached to the weighted jighead and the fishing hook, a movement of the bait mimics a natural caridoid escape reaction of an arthropod;
the weighted jighead further comprising a density in a range between one eighth (0.125) ounces to one (1) ounce;
forming a fishing hook having a shape further comprising an eye, a shank extending from said eye comprising a bend, a barb located near an end of said shank which terminates in a point at the end of said shank, and a gap which defines the bend as a distance between the shank and the point;
placing at least a portion of said formed fishing hook in the mold having the fan-like shape formed to mimic the at least one posterior division and the at least one posterior appendage of the crustacean;
pouring at least one liquefied material comprising lead, steel, brass, bismuth, a metallic amalgam, a composite resin, or other dense and low corrosive material into said mold; and
mold further comprises a shape of an open-ended, curved attachment apparatus wherein the movably attachable weighted jighead attaches to an eye of a fishing hook.

These and other exemplary aspects of the present invention are described herein.

Those skilled in the art will recognize still other aspects of the present invention upon reading and understanding the attached description.

### BRIEF DESCRIPTION OF THE DRAWINGS

The present invention is illustrated by way of example, and not in limitation, in the figures of the accompanying drawings.

FIG. 1 illustrates an exemplary embodiment of the present invention, including a fishing hook with a removably attachable jighead apparatus.

FIG. 2 illustrates an exemplary embodiment of the present invention, including a removably attachable jighead apparatus.

FIG. 3 illustrates an exemplary embodiment of the present invention, including a fishing hook with a removably attachable jighead apparatus with an exemplary artificial bait attached therein.

FIG. 4 illustrates an additional exemplary embodiment of the present invention, including a fishing hook with an attached jighead apparatus.

FIG. 5 illustrates an additional exemplary embodiment of the present invention, further including a fishing hook with an attached jighead apparatus with an exemplary artificial bait attached therein.

FIG. 6 illustrates one exemplary method of manufacturing a removably attachable jighead apparatus according to the present inventive concept.

### DETAILED DESCRIPTION OF THE INVENTION

The present invention will now be described more fully herein after with reference to the accompanying drawings, which form a part hereof, and which show, by way of illustration, specific exemplary embodiments by which the invention may be practiced. This invention may, however, be embodied in many different forms and should not be construed as limited to the exemplary embodiments set forth herein. Rather, these exemplary embodiments are provided so that this disclosure will be thorough and complete, and will fully convey the scope of the invention to those skilled in the art. Among other things, the present invention may be embodied as methods or devices. Accordingly, various exemplary embodiments may take the form of an entirely hardware embodiments, an entirely software embodiment and/or an embodiment combining software and hardware aspects. The following detailed description is, therefore, not to be taken in a limiting sense.

Throughout the specification and claims, the following terms take the meanings explicitly associated herein, unless the context clearly otherwise. The phrase “in one embodiment” as used herein does not necessarily refer to the same embodiment, though it may. Furthermore, the phrase “in another embodiment” as used herein does not necessarily refer to a different embodiment, although it may. Thus, as described below, various embodiments of the invention may be readily combined, without departing from the scope or spirit of the invention.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

The following briefly describes the embodiments of the invention in order to provide a basic understanding of some aspects of the invention. This brief description is not intended as an extensive overview. It is not intended to identify key or critical elements, or to delineate or otherwise narrow the scope. Its purpose is merely to present some concepts in a simplified form as a prelude to the more detailed description that is presented later.

The present invention generally relates to a fishing hook with a removably detachable jighead apparatus which generally has the shape and definition of a tail of a crustacean such as a shrimp or crawfish. This shape and definition is particularly inventive in that the removably detachable nature of the jighead apparatus simulates or mimics the natural movement of a crustacean when a bait is attached and in use in saltwater, brackish water and/or freshwater.

FIG. 1 illustrates one exemplary embodiment of a fishing hook 100, comprising an eye 110, a weighted jighead 120 movably attached to the eye 110, a shank 130 extending from the eye 110 with a bend 132, a barb 140 located near an end of the shank 130 which terminates in a point 142 at the end of the shank 130, and a gap 150 which defines the bend 132 as a distance between the shank 130 and the point 142.

As illustrated in FIG. 1, fish hook 100 comprises an eye 110. Eye 110 of fishing hook 100 can be defined as the location where fishing hook 100 is connected to line, for example braid, monofilament, fluorocarbon and/or nanofil. Eye 110 can optionally be designed to be optimized for strength, weight and/or presentation depending on the necessity for the fishing hook 100.

Eye 110 is illustrated as having a rounded cylindrical shape with a hollow center, however there are different types of eyes 110, including but not limited to, a ring or ball eye, a brazed eye where the eye is fully closed, a tapered eye to reduce weight, a looped eye, and/or no eye at all but, for example, a flattened area to allow secure snelling of a leader to the fishing hook 100.

In additional exemplary aspects of the present invention, eye 110 can also be positioned, including but not limited to, one of three ways on shank 130, for example, up turned, down turned and/or straight.

FIG. 2 further illustrates fishing hook 100 comprising a removably detachable weighted jighead 120. Jighead 120 generally has the shape and scaled dimension similar to a crustacean tail. Generally, a jighead comprises a function similar to a fishing sinker or knoch, which can be defined as a weight used in conjunction with a fishing lure or hook to increase its rate of sink, anchoring ability, and/or casting distance. Generally, a fishing sinkers may be as small as 1 gram for applications in shallow water, and even smaller for fly fishing applications, or as large as several pounds or considerably more for deep sea fishing. They are formed into nearly innumerable shapes for diverse fishing applications.

As will be illustrated in further detail in FIG. 3, when a bait is attached to the jighead 120 and attached to shank 130 via barb 140 and point 142, movement of the bait when attached to jighead 120 and attached to said shank 130 via barb 140 and point 142 mimics a natural caridoid escape reaction of an arthropod, such as a shrimp and/or other crustacean.

The term shrimp is generally used to refer to some decapod crustaceans, although the exact species of animals covered can vary. Used broadly, it may cover any of the groups with elongated bodies and a primarily swimming mode of locomotion—chiefly Caridea and Dendrobranchiata. Additionally, however, the term can be used more narrowly, and may be restricted to Caridea, to smaller species of either group, or to only the marine species.

Under the broader definition, shrimp can optionally be synonymous with prawn, covering stalk-eyed swimming crustaceans with long narrow muscular tails, also known as abdomens, long whiskers, commonly called antennae, and slender legs. These creatures swim forward by paddling with swimmerets on the underside of their abdomens. Crabs and lobsters have strong walking legs, whereas shrimp have thin fragile legs which they use primarily for perching.

Shrimp play important roles in the food chain and are important food sources for larger animals from fish to whales. The muscular tail portion of these crustaceans are what are attractive for consumption, lending to the inventive feature shape of jighead 120.

Further descriptive details will be illustrated in FIGS. 2 and 3, and will be described in reference therein.

Fishing hook 100 as illustrated in FIG. 1 further includes shank 130 with bend 132. Shank 130 and bend 132, for example, generally defines a shape and name for fishing hook 100, however, shank 130 can optionally have numerous variations lending to numerous names. In some cases hooks are identified by a traditional or historic name, e.g. Aberdeen, Limerick or O'Shaughnessy. In other cases, hooks are merely identified by their general purpose or have included in their name, one or more of their physical characteristics.

In FIG. 1, shank 130 is illustrated generally as a straight shaft with bend 132 having a generally semi-circular shape. However, this illustration should not be taken as limiting on the inventive concept in any way, as the shape of shank 130, for example, can vary widely from, including but not limited to, merely straight to all sorts of curves, kinks, bends and offsets. These different shapes contribute in some cases to better hook penetration, fly imitations or bait holding ability.

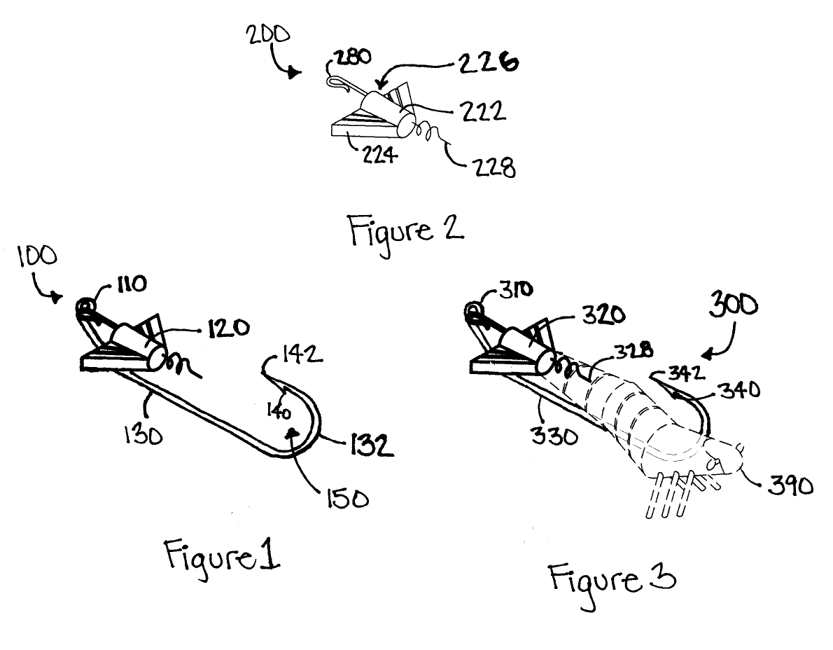

Many hooks, for example fishing hook 100, can be intended to hold live, dead and/or artificial baits, and therefore can optionally have sliced shanks, which can optionally create barbs, such as barb 140, for better baiting holding ability. As will be illustrated in more detail with reference to FIG. 4, fishing hooks, similar to fishing hook 400, can be designed to have a weight, such as weight 430, molded onto the shank, such as shank 420. Optionally, hook descriptions may also include shank length as standard, extra long, 2XL, short, or the like with a wire size such as fine wire, extra heavy, 2X heavy, or similar.

FIG. 1 further illustrates fish hook 100 having barb 140 which has point 142. Point 142 is the location at which fishing hook 100 attaches to and/or penetrates fish flesh and secures the fish. A profile of point 142 and its length influence how well point 142 attaches and/or penetrates. Barb 140 influences how far point 142 penetrates, how much pressure is required to penetrate and ultimately the holding power of hook 100.

Points can be, for example, mechanically, otherwise known as ground, and/or chemically sharpened. In additionally embodiments of the present invention, hook 100 can be barbless, however will continue to point 142. Historically, many ancient fish hooks were barbless, but modernly a barbless hook is used to make hook removal and fish release less stressful on the fish.

Point 142 can further be defined relative to an offset from the shank 130, herein defined as gap 150. In one example, a kirbed hook point 142 can be offset to the left, whereas a straight point 142 has no offset and a reversed point 142 is offset to the right. Point 142 can commonly be referred to, for example but in no way in limitation, by these names: needle point, rolled-in, hollow, spear, beak, mini-barb, semi-dropped and/or knife edge. Some other hook point names are used for branding by manufacturers.

Fishing hook 100 as further illustrated in FIG. 1 additionally depicts gap 150, which can be defined as a distance between shank 130 and barb 140 with point 142 finally defining said gap dimension. Generally, gap 150 dimension can define a large of sizes for hook 100. There are no internationally recognized standards for hooks and thus size is somewhat inconsistent between manufacturers. However, within a manufacturer's range of hooks, hook sizes are consistent.

Hook sizes generally are referred to by a numbering system that places the size one (1) hook in the middle of the size range. Smaller hooks are referenced by larger whole numbers (e.g. 1, 2, 3 . . . ). Larger hooks are referenced by increasing whole numbers followed by a slash and a zero (e.g. 1/0, 2/0, 3/0 . . . ), generally named “aught” as their size increases. The numbers represent relative sizes, normally associated with gap 150. The smallest size available is 32 and largest 20/0. As defined but not illustrated in FIG. 1, gap 150 distance is considered to be in a range between thirty-two (32) and twenty aught (20/0).

FIG. 2 illustrates one embodiment of a removably attachable weighted jighead 220 which comprises at least one posterior division 222 and at least one posterior appendage 224, which forms a fan-like shape 226. Jighead 224 also comprises an attachment apparatus 228 and an open-ended, curved attachment apparatus 280.

As illustrated in FIG. 2, jighead 220 has at least one posterior division 222. Posterior division 222, as illustrated, is similar in size and dimension to a telson of a crustacean. A telson can be defined as a posterior-most division of the body of an arthropod. In general terms, it is not considered a true segment because it does not arise in the embryo from teloblast areas as do real segments. A teslon generally never carries any appendages, but a forked tail, which may also be called a caudal furca, may be present to which appendages may be attached. The shape and composition of the telson differs between arthropod groups. Such caudal furca shape is not illustrated in FIG. 2 as an element of the at least one poster division 222, however, additional embodiments are contemplated to have such additional element(s).

FIG. 2 further illustrates jighead 220 having at least one posterior appendage 224. At least one posterior appendage 224 is similar in size and shape to a uropod. Uropods generally are posterior appendages found on a wide variety of crustaceans. A uropod typically has a function in locomotion. Uropods are often defined as the appendages of the last body segment of a crustacean. An alternative definition narrows the defined appendages to those structures arising from the segment before the anal segment. Under this latter definition, the appendages of the anal segment are caudal rami, which are analogous to uropods.

As illustrated in FIG. 2, at least one posterior appendage 224 is illustrated as having a fan-like shape 226. The further function is this fan-like shape 226 will be described in further detail with reference to FIG. 3. Fan-like shape 226 is herein illustrated in FIG. 2 as having a triangular shape, however, rounded edges are also considered in additional embodiments. Uropods are typically biramous, commonly defined as comprising an endopod and an exopod. The exopod is typically the larger, and may be divided into two or more sections by a transverse suture known as the diaeresis. Therefore, a posterior appendage, similar to at least one posterior appendage 224, can have any same that is functionally compatible with then necessary locomotion habits of an arthropod.

Jighead 220, as illustrated in FIG. 2, an attachment apparatus 228 which functions to hold a bait, live and/or artificial to jighead 220. As illustrated in FIG. 2, attachment apparatus 228 has a spiral shape, however, any functionally reasonable shape may be used. Examples include, but are not limited to, a straight shape, a curved shape, and helical and/or double helical shape, or any other geometrically possible and/or necessary shape.

FIG. 2 further illustrates jighead 220 having an open-ended, curved attachment apparatus 280 whereby jighead 220 attaches to a hook. Attachment apparatus 280 is illustrated in FIG. 2 as being open-ended, and curved, however, any functionally compatible shape and/or design is considered in additional embodiments. Examples include, but are not limited to, a square shape, any curved shape such as a semicubical parabola, serpentine curve, and/or trident curve, as well as any conical and/or ellipsoid curve, and/or any other functionally necessary and compatible design as needed.

Additionally, jighead 220 as illustrated in FIG. 2 has a density which can optionally be within a range between one eighth (0.125) ounces to one (1) ounce. Also, jighead 220 can be cast in at least one material comprising lead, steel, brass, bismuth, a metallic amalgam, a composite resin, or other dense and low corrosive material. Additional materials are also considered in additional embodiments, including but not limited to, hard plastics, or any other functionally compatible and formable material which may currently exist or which may be designed and manufactured in the future.

FIG. 3 illustrates one illustrative embodiment of the present inventive fishing hook 300, with all the elements as listed above in FIGS. 1 and 2, respectively, supra, with a bait 390 attached to jighead 320 and also attached to shank 330 via the barb 340 and point 342. Where bait 390 is attached to jighead 320 via attachment apparatus 328, movement of bait 390 mimics a natural caridoid escape reaction of an arthropod.

The caridoid escape reaction, also known as lobstering or tail-flipping, refers to an innate escape mechanism in marine and freshwater crustaceans such as lobsters, hill, shrimp and crayfish. The reaction allows crustaceans to escape predators through rapid abdominal flexions that produce powerful swimming strokes thrusting the crustacean backwards through the water and away from danger. The type of response depends on the part of the crustacean stimulated, but this behavior is complex and is regulated both spatially and temporally through the interactions of several neurons.

Bait 390 is illustrated in FIG. 3 as being an artificial, soft plastic-like bait. Artificial baits are commonly lures made of plastic or rubber designed to look like fish, crabs, squid, worms, lizards, frogs, leeches and other creature that are injured, so as to attract a animal such as a fish, in the water. However, bait 390 is further contemplated to be a live bait, a bait that is actually injured so as to further attract an animal, such as a fish or shark, in the water.

Decapods crustaceans, such as shrimp, crayfish and lobsters, possesses a hard, segmented exoskeleton that reflects muscular and neural segmentation. The abdominal section of these arthropods are divided into segments that are flexibly interconnected, forming the tail. Normally, the tail is held in an extended position to aid in maneuvering and balancing. The first five segments are similar and the two terminal segments are modified into a tail fan, a region with high surface area that acts as the blade of a paddle in the escape response. This region contains the telson as described above.

In one exemplary use of fishing hook 300 where a live bait 390 is attached, the tail section of bait 390 is typically removed and an abdominal section of bait 390 is attached directly to jighead 320 via the attachment apparatus 328 and also attached to shank 330 via barb 340 having point 342 which can pierce through the exoskeleton. I this example, the injury of bait 390 causes attraction of marine animals, such as fish, in the near vicinity. Since bait 390 lacks a main feature of escape movement, jighead 320 reasonably acts as a replacement mechanism for this, and allows the injured arthropod to continue to mimic natural caridoid escape motion, however with the additional assistance of an angler controlling fishing hook 300.

FIG. 4 illustrates another exemplary embodiment of a fishing hook 400 comprising an eye 410, a shank 420 extending from eye 410 comprising a bend 422, a weight 430 affixed to shank 420, a barb 440 located near an end of shank 420 which terminates in a point 442 at the end of shank 420, and a gap 450 which defines bend 442 as a distance between shank 420 and point 442.

As illustrated in FIG. 4, fish hook 400 comprises an eye 410. Eye 410 of fishing hook 400 can be defined as the location where fishing hook 400 is connected to line, for example braid, monofilament, fluorocarbon and/or nanofil. Eye 410 can optionally be designed to be optimized for strength, weight and/or presentation depending on the necessity for the fishing hook 400.

Eye 410 is illustrated as having a rounded cylindrical shape with a hollow center, however there are different types of eyes 410, including but not limited to, a ring or ball eye, a brazed eye where the eye is fully closed, a tapered eye to reduce weight, a looped eye, and/or no eye at all but, for example, a flattened area to allow secure snelling of a leader to the fishing hook 400.

In additional exemplary aspects of the present invention, eye 410 can also be positioned, including but not limited to, one of three ways on shank 420, for example, up turned, down turned and/or straight.

Fishing hook 400 as illustrated in FIG. 4 further includes shank 420 with bend 422. Shank 420 and bend 422, for example, generally defines a shape and name for fishing hook 400, however, shank 420 can optionally have numerous variations lending to numerous names. In some cases hooks are identified by a traditional or historic name, e.g. Aberdeen, Limerick or O'Shaughnessy. In other cases, hooks are merely identified by their general purpose or have included in their name, one or more of their physical characteristics.

In FIG. 4, shank 420 is illustrated generally as a straight shaft with bend 422 having a generally semi-circular shape. However this illustration should not be taken as limiting on the inventive concept in any way, as the shape of shank 420, for example, can vary widely from, including but not limited to, merely straight to all sorts of curves, kinks, bends and offsets. These different shapes contribute in some cases to better hook penetration, fly imitations or bait holding ability. Many hooks, for example fishing hook 400, can be intended to hold live, dead and/or artificial baits, and therefore can optionally have sliced shanks, which can optionally create barbs, such as barb 440, for better baiting holding ability. Optionally, hook descriptions may also include shank length as standard, extra long, 2XL, short, or the like with a wire size such as fine wire, extra heavy, 2X heavy, or similar.

As further illustrated in FIG. 4, fishing hook 400, can have a weight 430 molded onto shank 420. Weight 430 can have fan-like shape 434 formed to mimic at least one posterior division and at least one posterior appendage of a crustacean and can have a density in a range between one eighth (0.125) ounces to one (1) ounce. Additionally weight 430 can have an attachment apparatus 434.

Weight 430 can optionally be cast in at least one material comprising lead, steel, brass, bismuth, a metallic amalgam, a composite resin, or other dense and low corrosive material.

As described in more detail in reference to FIG. 2, supra, weight 430 can have at least one posterior division and at least one posterior appendage which form a fan-like shape 432.

Fan-like shape 432 is depicted in FIG. 4 as having a triangular shape, however, rounded edges are also considered in additional embodiments. Uropods are typically biramous, commonly defined as comprising an endopod and an exopod. The exopod is typically the larger, and may be divided into two or more sections by a transverse suture known as the diaeresis. Therefore, a posterior appendage can have any same that is functionally compatible with then necessary locomotion habits of an arthropod.

Additionally, weight 430 as illustrated in FIG. 4 has an attachment apparatus 434 which functions to hold a bait, live and/or artificial to weight 430. As illustrated in FIG. 3, attachment apparatus 430 has a bullet-like, beveled-ridged shape; however, any functionally reasonable shape may be used. Examples include, but are not limited to, any edging style that is functionally compatible, geometrically possible and/or necessary shape.

FIG. 4 further illustrates fish hook 400 having barb 440 which has point 442. Point 442 is the location at which fishing hook 400 attaches to and/or pierces fish flesh and secures the fish. A profile of point 442 and its length influence how well point 442 attaches and/or penetrates. Barb 440 influences how far point 442 penetrates, how much pressure is required to penetrate and ultimately the holding power of hook 400.

Points can be, for example, mechanically, otherwise known as ground, and/or chemically sharpened. In additionally embodiments of the present invention, hook 400 can be barbless, however will continue to point 442. Historically, many ancient fish hooks were barbless, but modernly a barbless hook is used to make hook removal and fish release less stressful on the fish.

Point 442 can further be defined relative to an offset from the shank 420, herein defined as gap 450. In one example, a kirbed hook point 442 can be offset to the left, whereas a straight point 442 has no offset and a reversed point 442 is offset to the right. Point 442 can commonly be referred to, for example but in no way in limitation, by these names: needle point, rolled-in, hollow, spear, beak, mini-barb, semi-dropped and/or knife edge. Some other hook point names are used for branding by manufacturers.

Fishing hook 400 as further illustrated in FIG. 4 additionally depicts gap 450, which can be defined as a distance between shank 430 and barb 440 with point 442 finally defining said gap dimension. Generally, gap 450 dimension can define a large range of sizes for hook 400. There are no internationally recognized standards for hooks and thus size is somewhat inconsistent between manufacturers. However, within a manufacturer's range of hooks, hook sizes are consistent.

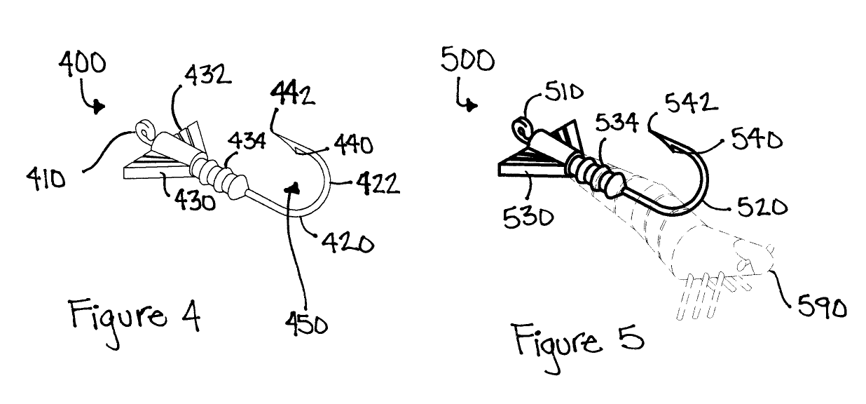

As will be illustrated in further detail in FIG. 5, when a bait is attached to the fishing hook 400, the bait is attached to said shank 420 via barb 440 and point 442, and additionally attached to weight 420 via attachment apparatus 434. Attachment apparatus 434, in this illustrative example, acts as an augmenting bond in addition to the attaching properties of shank 420, barb 440 and point 442. In addition, the shape and dimension of weight 430, in the form of fan-like shape 432 allows a bait attached to fishing hook 400 to minimally have a motion that mimic a natural caridoid escape reaction of an arthropod, such as a shrimp and/or other crustacean.

FIG. 5 illustrates one illustrative embodiment of the present inventive fishing hook 500, with all the elements as listed above in FIG. 4, respectively, supra., with a bait 490 attached to weight 430 via shank 520, barb 540 and point 542. Where bait 590 is attached to weight 530 via attachment apparatus 534, movement of bait 590 minimally mimics a natural caridoid escape reaction of an arthropod.

The caridoid escape reaction, also known as lobstering or tail-flipping, refers to an innate escape mechanism in marine and freshwater crustaceans such as lobsters, hill, shrimp and crayfish. The reaction allows crustaceans to escape predators through rapid abdominal flexions that produce powerful swimming strokes thrusting the crustacean backwards through the water and away from danger. The type of response depends on the part of the crustacean stimulated, but this behavior is complex and is regulated both spatially and temporally through the interactions of several neurons.

Bait 590 is illustrated in FIG. 5 as being an artificial, soft plastic-like bait. Artificial baits are commonly lures made of plastic or rubber designed to look like fish, crabs, squid, worms, lizards, frogs, leeches and other creature that are injured, so as to attract a animal such as a fish, in the water. However, bait 590 is further contemplated to be a live bait, a bait that is actually injured so as to further attract an animal, such as a fish or shark, in the water.

In one exemplary use of fishing hook 500 where a live bait 590 is attached, the tail section of bait 590 is typically removed and an abdominal section of bait 590 is attached directly to weight 530 via the attachment apparatus 534 through shank 520, barb 540 and point 542 which can pierce through the exoskeleton and subsequently the body of bait 590. In this example, the injury of bait 590 causes attraction of marine animals, such as fish, in the near vicinity. Since bait 590 lacks a main feature of escape movement, weight 530 minimally acts as a replacement mechanism for this, and allows the injured arthropod to continue to minimally mimic natural caridoid escape motion, however with the additional assistance of an angler controlling fishing hook 500.

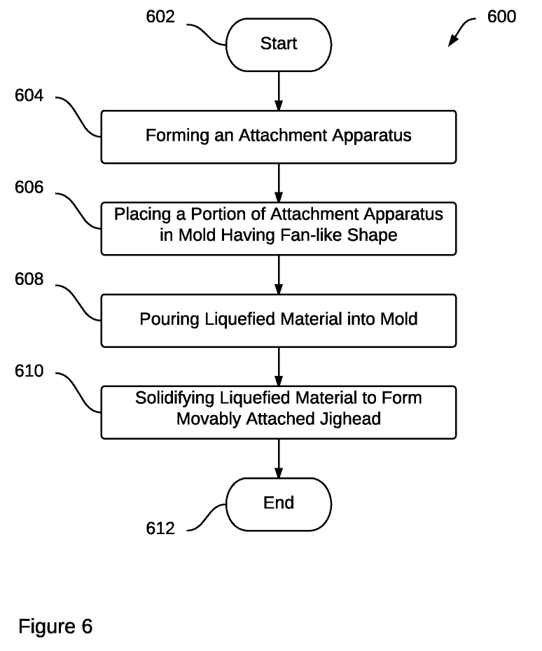

FIG. 6 illustrates one exemplary method of manufacturing a movably attachable jighead. Method 600 starts at 602 with forming an attachment apparatus at 604. The attachment apparatus can be formed of any material that is functionally compatible, however this method contemplates formation of the attachment apparatus using at least one material comprising lead, steel, brass, bismuth, a metallic amalgam, a composite resin, or other dense and low corrosive material.

At 606, the method continues with placing at least a portion of the formed attachment apparatus in a mold having a fan-like shape. The mold is particularly contemplated to have such a shape, as described in more detail with reference to FIG. 2, to mimic at least one posterior division and at least one posterior appendage of a crustacean for reasons as described above, supra.

At 608, the method continues with pouring at least one liquefied material comprising lead, steel, brass, bismuth, a metallic amalgam, a composite resin, or other dense and low corrosive material into said mold and, thereafter at 610 solidifying the at least one liquefied material to form the movably attachable weighted jighead. The method thereafter ends at 612.

Additional method steps are contemplated but not illustrated in FIG. 6. One of these steps includes, but is not limited to forming a fishing hook having a shape further comprising an eye, a shank extending from said eye comprising a bend, a barb located near an end of said shank which terminates in a point at the end of said shank, and a gap which defines the bend as a distance between the shank and the point.

Another of these steps includes, but is not limited to placing at least a portion of the formed fishing hook in the mold having the fan-like shape formed to mimic the at least one posterior division and the at least one posterior appendage of the crustacean.

Additional aspects are further contemplated as part of this method, but are not limited to the attachment apparatus having a spiral-shape, weighted jighead further comprises a density in a range between one eighth (0.125) ounces to one (1) ounce, and the mold further comprising a shape of an open-ended, curved attachment apparatus where the movably attachable weighted jighead attaches to an eye of a fishing hooks.

Additional methods, aspects and elements of the present inventive concept are contemplated in use in conjunction with individually or in any combination thereof which will create a reasonably function device to be of use as a grabbing apparatus to removably connect to a docking location. Methods of use are also contemplated using all optional aspects and embodiments as described above, individually or in combination thereof.

It will be apparent to one of ordinary skill in the art that the manner of making and using the claimed invention has been adequately disclosed in the above-written description of the exemplary embodiments and aspects. It should be understood, however, that the invention is not necessarily limited to the specific embodiments, aspects, arrangement and components shown and described above, but may be susceptible to numerous variations within the scope of the invention.

Moreover, particular exemplary features described herein in conjunction with specific embodiments and/or aspects of the present invention are to be construed as applicable to any embodiment described within, enabled thereby, or apparent wherefrom. Thus, the specification and drawings are to be regarded in a broad, illustrative, and enabling sense, rather than a restrictive one.

Further, it will be understood that the above description of the embodiments of the present invention are susceptible to various modifications, changes, and adaptations, and the same are intended to be comprehended within the meaning and range of equivalents of the appended claims.

Therefore, I claim:

1. A fishing hook, comprising:
an eye;
a weighted jighead movably attached to said eye;
a shank extending from said eye comprising a bend;
a barb located near an end of said shank which terminates in a point at the end of said shank; and
a gap which defines the bend as a distance between the shank and the point;
wherein a bait is attached to said weighted jighead and attached to said shank via the barb and the point, and
wherein a movement of the bait when attached to said weighted jighead and attached to said shank via the barb and the point mimics a natural caridoid escape reaction of an arthropod.

2. The fishing hook of claim 1, wherein the weighted jighead further comprises at least one posterior division and at least one posterior appendage of a crustacean, which forms a fan-like shape.

3. The fishing hook of claim 1, wherein the weighted jighead further comprises an attachment apparatus which further comprises a spiral shape.

4. The fishing hook of claim 1, wherein the weighted jighead further comprises a density in a range between one eighth (0.125) ounces to one (1) ounce.

5. The fishing hook of claim 1, wherein the weighted jighead is cast in at least one material comprising lead, steel, brass, bismuth, a metallic amalgam, a composite resin, or other dense and low corrosive material.

6. The fishing hook of claim 1, wherein the weighted jighead is movably attached to the eye via an open-ended, curved attachment apparatus.

7. The fishing hook of claim 1, wherein the gap distance further defines a size of the fishing hook in a range between thirty-two (32) and twenty aught (20/0).

8. The fishing hook of claim 1, wherein the bait is an artificial bait further comprised of a soft, plastic-based material.

9. The fishing hook claim 1, wherein the bait is a live crustacean.

10. A fishing hook, comprising:
an eye;
a shank extending from said eye comprising a bend;
a weight affixed to said shank;
a barb located near an end of said shank which terminates in a point at the end of said shank; and
a gap which defines the bend as a distance between the shank and the point;
wherein a bait is affixed to said shank via an attachment element of said weight affixed to said shank.

11. The fishing hook of claim 10, wherein the weight further comprises a fan-like shape formed to mimic at least one posterior division and at least one posterior appendage of a crustacean.

12. The fishing hook of claim 10, wherein a movement of the bait when attached to the fishing hook mimics a natural caridoid escape reaction.

13. The fishing hook of claim 10, wherein the weighted jighead further comprises a density in a range between one eighth (0.125) ounces to one (1) ounce.

14. The fishing hook of claim 10, wherein the gap distance further defines a size of the fishing hook in a range between thirty-two (32) and twenty aught (20/0).

15. A method of manufacturing a movably attachable jighead, comprising:
forming an attachment apparatus;
placing at least a portion of said formed spiral-shaped attachment apparatus in a mold having a fan-like shape formed to mimic at least one posterior division and at least one posterior appendage of a crustacean;
pouring at least one liquefied material comprising lead, steel, brass, bismuth, a metallic amalgam, a composite resin, or other dense and low corrosive material into said mold; and
solidifying said at least one liquefied material to form the movably attachable weighted jighead.

16. The method of claim 15, wherein the attachment apparatus has a spiral-shape.

17. The method of claim 15, wherein when the weighted jighead is movably attached to a fishing hook and a bait is attached to the weighted jighead and the fishing hook, a movement of the bait mimics a natural caridoid escape reaction of an arthropod.

18. The method of claim 15, wherein the weighted jighead further comprises a density in a range between one eighth (0.125) ounces to one (1) ounce.

19. The method of claim 15, further comprising the steps of:
forming a fishing hook having a shape further comprising an eye, a shank extending from said eye comprising a bend, a barb located near an end of said shank which terminates in a point at the end of said shank, and a gap which defines the bend as a distance between the shank and the point;
placing at least a portion of said formed fishing hook in the mold having the fan-like shape formed to mimic the at least one posterior division and the at least one posterior appendage of the crustacean; and
pouring at least one liquefied material comprising lead, steel, brass, bismuth, a metallic amalgam, a composite resin, or other dense and low corrosive material into said mold.

20. The method of claim 15, wherein the mold further comprises a shape of an open-ended, curved attachment apparatus wherein the movably attachable weighted jighead attaches to an eye of a fishing hook.
